(19) United States
(12) Patent Application Publication
(10) Pub. No.: US 2021/0143401 A1
(43) Pub. Date: May 13, 2021

(54) CONTROL OF THERMAL TRANSFER DURING ELECTRODE PYROLYSIS BASED PROCESSING

(71) Applicant: ENEVATE CORPORATION, Irvine, CA (US)

(72) Inventors: Fred Bonhomme, Lake Forest, CA (US); Benjamin Park, Mission Viejo, CA (US); Todd Tatar, Irvine, CA (US); Ian Browne, Orange, CA (US)

(21) Appl. No.: 16/678,914

(22) Filed: Nov. 8, 2019

(51) Int. Cl. H01M 4/1393; H01M 4/133; H01M 10/0525

(52) U.S. Cl. CPC H01M 4/1393; H01M 10/0525; H01M 4/133

(57) ABSTRACT

Systems and methods are provided for control of thermal transfer during electrode pyrolysis based processing. A thermal rod may be used for processing battery electrodes, with the thermal rod being configured for engaging an electrode roll. At least a portion of the thermal rod is disposed within the electrode roll once it is engaged with the electrode roll, and the thermal rod is configured for providing thermal transfer into the electrode roll during processing of the electrode roll, with the processing including pyrolysis processing of the electrode roll.

### TECHNICAL FIELD

Aspects of the present disclosure relate to energy generation and storage. More specifically, certain implementations of the present disclosure relate to methods and systems for control of thermal transfer during electrode pyrolysis based processing.

### BACKGROUND

Various issues may exist with conventional battery technologies. In this regard, conventional systems and methods, if any existed, for implementing battery electrodes may be costly, cumbersome, and/or inefficient—e.g., they may be complex and/or time consuming to implement, and may limit battery lifetime.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for control of thermal transfer during electrode pyrolysis based processing, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1 is a diagram of a battery with electrode processed using thermal transfer during electrode pyrolysis, in accordance with an example embodiment of the disclosure.

FIG. 2 illustrates an example silicon-dominant anode, in accordance with an example embodiment of the disclosure.

FIG. 3 is a flow diagram of a process for direct coating electrodes, in accordance with an example embodiment of the disclosure.

FIG. 4 is a flow diagram of an alternative process for transfer lamination of electrodes, in accordance with an example embodiment of the disclosure.

FIG. 5 illustrates an example combination of thermal rod and electrode roll that may be used for controlled thermal transfer during electrode pyrolysis, in accordance with an example embodiment of the disclosure.

FIG. 6 illustrates example use of an electrode roll incorporating a thermal rod in a furnace, in accordance with an example embodiment of the disclosure.

FIG. 7 illustrates an example use of multiple electrode rolls, each incorporating a thermal rod in a continuous batch furnace, in accordance with an example embodiment of the disclosure.

### DETAILED DESCRIPTION

FIG. 1 is a diagram of a battery with electrode processed using thermal transfer during electrode pyrolysis, in accordance with an example embodiment of the disclosure. Referring to FIG. 1, there is shown a battery 100 comprising a separator 103 sandwiched between an anode 101 and a cathode 105, with current collectors 107A and 107B. There is also shown a load 109 coupled to the battery 100 illustrating instances when the battery 100 is in discharge mode. In this disclosure, the term “battery” may be used to indicate a single electrochemical cell, a plurality of electrochemical cells formed into a module, and/or a plurality of modules formed into a pack.

The development of portable electronic devices and electrification of transportation drive the need for high performance electrochemical energy storage. Small-scale (<100 Wh) to large-scale (>10 KWh) devices primarily use lithium-ion (Li-ion) batteries over other rechargeable battery chemistries due to their high-performance.

The anode 101 and cathode 105, along with the current collectors 107A and 107B, may comprise the electrodes, which may comprise plates or films within, or containing, an electrolyte material, where the plates may provide a physical barrier for containing the electrolyte as well as a conductive contact to external structures. In other embodiments, the anode/cathode plates are immersed in electrolyte while an outer casing provides electrolyte containment. The anode 101 and cathode are electrically coupled to the current collectors 107A and 107B, which comprise metal or other conductive material for providing electrical contact to the electrodes as well as physical support for the active material in forming electrodes.

The configuration shown in FIG. 1 illustrates the battery 100 in discharge mode, whereas in a charging configuration, the load 107 may be replaced with a charger to reverse the process. In one class of batteries, the separator 103 is generally a film material, made of an electrically insulating polymer, for example, that prevents electrons from flowing from anode 101 to cathode 105, or vice versa, while being porous enough to allow ions to pass through the separator 103. Typically, the separator 103, cathode 105, and anode 101 materials are individually formed into sheets, films, or active material coated foils. Sheets of the cathode, separator and anode are subsequently stacked or rolled with the separator 103 separating the cathode 105 and anode 101 to form the battery 100. In some embodiments, the separator 103 is a sheet and generally utilizes winding methods and stacking in its manufacture. In these methods, the anodes, cathodes, and current collectors (e.g., electrodes) may comprise films.

In an example scenario, the battery 100 may comprise a solid, liquid, or gel electrolyte. The separator 103 preferably does not dissolve in typical battery electrolytes such as compositions that may comprise: Ethylene Carbonate (EC), Fluoroethylene Carbonate (FEC), Propylene Carbonate (PC), Dimethyl Carbonate (DMC), Ethyl Methyl Carbonate (EMC), Diethyl Carbonate (DEC), etc. with dissolved LiBF₄, LiAsF₆, LiPF₆, and LiClO₄ etc. The separator 103 may be wet or soaked with a liquid or gel electrolyte. In addition, in an example embodiment, the separator 103 does not melt below about 100 to 120° C., and exhibits sufficient mechanical properties for battery applications. A battery, in operation, can experience expansion and contraction of the anode and/or the cathode. In an example embodiment, the separator 103 can expand and contract by at least about 5 to 10% without failing, and may also be flexible.

The separator 103 may be sufficiently porous so that ions can pass through the separator once wet with, for example, a liquid or gel electrolyte. Alternatively (or additionally), the separator may absorb the electrolyte through a gelling or other process even without significant porosity. The porosity of the separator 103 is also generally not too porous to allow the anode 101 and cathode 105 to transfer electrons through the separator 103.

The anode 101 and cathode 105 comprise electrodes for the battery 100, providing electrical connections to the device for transfer of electrical charge in charge and discharge states. The anode 101 may comprise silicon, carbon, or combinations of these materials, for example. Typical anode electrodes comprise a carbon material that includes a current collector such as a copper sheet. Carbon is often used because it has excellent electrochemical properties and is also electrically conductive. Anode electrodes currently used in rechargeable lithium-ion cells typically have a specific capacity of approximately 200 milliamp hours per gram. Graphite, the active material used in most lithium ion battery anodes, has a theoretical energy density of 372 milliamp hours per gram (mAh/g). In comparison, silicon has a high theoretical capacity of 4200 mAh/g. In order to increase volumetric and gravimetric energy density of lithium-ion batteries, silicon may be used as the active material for the cathode or anode. Silicon anodes may be formed from silicon composites, with more than 50% silicon, for example.

In an example scenario, the anode 101 and cathode 105 store the ion used for separation of charge, such as lithium. In this example, the electrolyte carries positively charged lithium ions from the anode 101 to the cathode 105 in discharge mode, as shown in FIG. 1 for example, and vice versa through the separator 105 in charge mode. The movement of the lithium ions creates free electrons in the anode 101 which creates a charge at the positive current collector 1078. The electrical current then flows from the current collector through the load 109 to the negative current collector 107A. The separator 103 blocks the flow of electrons inside the battery 100, allows the flow of lithium ions, and prevents direct contact between the electrodes.

While the battery 100 is discharging and providing an electric current, the anode 101 releases lithium ions to the cathode 105 via the separator 103, generating a flow of electrons from one side to the other via the coupled load 109. When the battery is being charged, the opposite happens where lithium ions are released by the cathode 105 and received by the anode 101.

The materials selected for the anode 101 and cathode 105 are important for the reliability and energy density possible for the battery 100. The energy, power, cost, and safety of current Li-ion batteries need to be improved in order to, for example, compete with internal combustion engine (ICE) technology and allow for the widespread adoption of electric vehicles (EVs). High energy density, high power density, and improved safety of lithium-ion batteries are achieved with the development of high-capacity and high-voltage cathodes, high-capacity anodes and functionally non-flammable electrolytes with high voltage stability and interfacial compatibility with electrodes. In addition, materials with low toxicity are beneficial as battery materials to reduce process cost and promote consumer safety.

The performance of electrochemical electrodes, while dependent on many factors, is largely dependent on the robustness of electrical contact between electrode particles, as well as between the current collector and the electrode particles. The electrical conductivity of silicon anode electrodes may be manipulated by incorporating conductive additives with different morphological properties. Carbon black (Super P), vapor grown carbon fibers (VGCF), and a mixture of the two have previously been incorporated separately into the anode electrode resulting in improved performance of the anode. The synergistic interactions between the two carbon materials may facilitate electrical contact throughout the large volume changes of the silicon anode during charge and discharge.

State-of-the-art lithium-ion batteries typically employ a graphite-dominant anode as an intercalation material for lithium. Silicon-dominant anodes, however, offer improvements compared to graphite-dominant Li-ion batteries. Silicon exhibits both higher gravimetric (3579 mAh/g vs. 372 mAh/g for graphite) and volumetric capacities (2194 mAh/L vs. 890 mAh/L for graphite). In addition, silicon-based anodes have a low lithiation/delithiation voltage plateau at about 0.3-0.4V vs. Li/Li+, which allows it to maintain an open circuit potential that avoids undesirable Li plating and dendrite formation. While silicon shows excellent electrochemical activity, achieving a stable cycle life for silicon-based anodes is challenging due to silicon's large volume changes during lithiation and delithiation. Silicon regions may lose electrical contact from the anode as large volume changes coupled with its low electrical conductivity separate the silicon from surrounding materials in the anode.

In addition, the large silicon volume changes exacerbate solid electrolyte interphase (SEI) formation, which can further lead to electrical isolation and, thus, capacity loss. Expansion and shrinkage of silicon particles upon charge-discharge cycling causes pulverization of silicon particles, which increases their specific surface area. As the silicon surface area changes and increases during cycling, SEI repeatedly breaks apart and reforms. The SEI thus continually builds up around the pulverizing silicon regions during cycling into a thick electronic and ionic insulating layer. This accumulating SEI increases the impedance of the electrode and reduces the electrode electrochemical reactivity, which is detrimental to cycle life.

FIG. 2 illustrates an example silicon-dominant anode, in accordance with an example embodiment of the disclosure. Referring to FIG. 2, there is shown an anode 200, a current collector 201, an adhesive 203, and an active material 205. It should be noted, however, that the adhesive 203 may or may not be present depending on the type of anode fabrication process utilized, as the adhesive is not necessarily there in a direct coating process where the active material is formed directly on the current collector.

In an example scenario, the active material 205 comprises silicon particles in a binder material and a solvent, the active material 205 being pyrolyzed to turn the binder into a glassy carbon that provides a structural framework around the silicon particles and also provides electrical conductivity. The active material may be coupled to the current collector 201 using the optional adhesive 203. The current collector 201 may comprise a metal film, such as copper, nickel, or titanium, for example, although other conductive foils may be utilized depending on desired tensile strength.

FIG. 2 also illustrates lithium particles impinging upon and lithiating the active material 205. Also, as illustrated in FIG. 2, the current collector 201 has a thickness t, which may vary based on the particular implementation. In this regard, in some implementations thicker foils may be used while in other implementations thinner foils are used. Example thicker foils may be greater than 6 μm, such as 10 μm or 20 μm for copper, for example, while thinner foils may be less than 6 μm thick in copper.

In an example scenario, when an adhesive is used, the adhesive 203 comprises a polymer such as polyimide (PI), Polyacrylic acid (PAA), Polyvinylidene fluoride (PVDF) or polyamide-imide (PAI) that provides adhesive strength of the active material film 205 to the current collector 201 while still providing electrical contact to the current collector 201. Other adhesives may be utilized depending on the desired strength, as long as they can provide adhesive strength with sufficient conductivity following processing.

FIG. 3 is a flow diagram of a process for direct coating electrodes, in accordance with an example embodiment of the disclosure. This process comprises physically mixing the active material, conductive additive, and binder together, and coating it directly on a current collector. This example process comprises a direct coating process in which an anode slurry is directly coated on a copper foil using a binder such as CMC, SBR, Sodium Alginate, PAI, PAA, PI, Polyacrylonitrile (PAN) and mixtures and combinations thereof. Another example process comprising forming the active material on a substrate and then transferring to the current collector is described with respect to FIG. 4.

In step 301, the raw electrode active material may be mixed using a binder/resin (such as PI, PAI), solvent, and conductive carbon. For example, graphene/VGCF (1:1 by weight) may be dispersed in NMP under sonication for, e.g., 1 hour followed by the addition of Super P (1:1:1 with VGCF and graphene) and additional sonication for, e.g., 45-75 minutes. Silicon powder with a desired particle size, may then be dispersed in polyamic acid resin (15% solids in N-Methyl pyrrolidone (NMP)) at, e.g., 1000 rpm in a ball miller for a designated time, and then the conjugated carbon/NMP slurry may be added and dispersed at, e.g., 2000 rpm for, e.g., another predefined time to achieve a slurry viscosity within 2000-4000 cP and a total solid content of about 30%. The particle size and mixing times may be varied to configure the active material density and/or roughness.

In step 303, the slurry may be coated on the foil at a loading of, e.g., 3-4 mg/cm², which may undergo drying in step 305 resulting in less than 15% residual solvent content. In step 307, an optional calendering process may be utilized where a series of hard pressure rollers may be used to finish the film/substrate into a smoother and denser sheet of material.

In step 309, the active material may be pyrolyzed by heating to 400-800° C. such that carbon precursors are partially or completely converted into glassy carbon. The pyrolysis step may result in an anode active material having silicon content greater than or equal to 50% by weight, where the anode has been subjected to heating at or above 400° C. Pyrolysis can be done either in roll form or after punching in step 311. If done in roll form, the punching is done after the pyrolysis process. The punched electrode may then be sandwiched with a separator and cathode with electrolyte to form a cell.

In step 313, the cell may be subjected to a formation process, comprising initial charge and discharge steps to lithiate the anode, with some residual lithium remaining.

FIG. 4 is a flow diagram of an alternative process for transfer lamination of electrodes, in accordance with an example embodiment of the disclosure. While the previous process to fabricate composite anodes employs a direct coating process, this process physically mixes the active material, conductive additive, and binder together coupled with peeling and lamination processes.

This process is shown in the flow diagram of FIG. 4, starting with step 401 where the active material may be mixed with a binder/resin such as polyimide (PI) or polyamide-imide (PAI), solvent, the silosilazane additive, and optionally a conductive carbon. As with the process described in FIG. 4, graphene/VGCF (1:1 by weight) may be dispersed in NMP under sonication for, e.g., 45-75 minutes followed by the addition of Super P (1:1:1 with VGCF and graphene) and additional sonication for, e.g., 1 hour. Silicon powder with a desired particle size, may then be dispersed in polyamic acid resin (10-20% solids in N-Methyl pyrrolidone (NMP)) at, e.g., 800-1200 rpm in a ball miller for a designated time, and then the conjugated carbon/NMP slurry may be added and dispersed at, e.g., 1800-2200 rpm for, e.g., another predefined time to achieve a slurry viscosity within 2000-4000 cP and a total solid content of about 30%. The particle size and mixing times may be varied to configure the active material density and/or roughness.

In step 403, the slurry may be coated on a polymer substrate, such as polyethylene terephthalate (PET), polypropylene (PP), or Mylar. The slurry may be coated on the PET/PP/Mylar film at a loading of 3-4 mg/cm² (with 15% solvent content), and then dried to remove a portion of the solvent in step 405. An optional calendering process may be utilized where a series of hard pressure rollers may be used to finish the film/substrate into a smoothed and denser sheet of material.

In step 407, the green film may then be removed from the PET, where the active material may be peeled off the polymer substrate, the peeling process being optional for a polypropylene (PP) substrate, since PP can leave −2% char residue upon pyrolysis. The peeling may be followed by a cure and pyrolysis step 409 where the film may be cut into sheets, and vacuum dried using a two-stage process (100-140° C. for 15 h, 200-240° C. for 5 h). The dry film may be thermally treated at 1000-1300° C. to convert the polymer matrix into carbon. The pyrolysis step may result in an anode active material having silicon content greater than or equal to 50% by weight, where the anode has been subjected to heating at or above 400° C.

In step 411, the pyrolyzed material may be flat press or roll press laminated on the current collector, where a copper foil may be coated with polyamide-imide with a nominal loading of 0.35-0.75 mg/cm² (applied as a 5-7 wt % varnish in NMP, dried 10-20 hour at 100-140° C. under vacuum). In flat press lamination, the silicon-carbon composite film may be laminated to the coated copper using a heated hydraulic press (30-70 seconds, 250-350° C., and 3000-5000 psi), thereby forming the finished silicon-composite electrode. In another embodiment, the pyrolyzed material may be roll-press laminated to the current collector.

In step 413, the electrode may then be sandwiched with a separator and cathode with electrolyte to form a cell. The cell may be subjected to a formation process, comprising initial charge and discharge steps to lithiate the anode, with some residual lithium remaining.

FIG. 5 illustrates an example combination of thermal rod and electrode roll that may be used for controlled thermal transfer during electrode pyrolysis, in accordance with an example embodiment of the disclosure. Shown in FIG. 5 is a thermal rod 510 engaging an electrode roll 520.

The thermal rod 510 may be configured to provide thermal transfer onto the electrode roll 520 during processing thereof, particularly during pyrolysis processing. In this regard, thermal transfer may include one or both of heating and cooling. This may be done to enhance quality of the processing of the electrode, by ensuring uniform heating and/or cooling during the processing. In this regard, the thermal rod 510 may be configured to engage electrode rolls internally (e.g., being inserted within them) to allow heating and/or cooling the electrode rolls from the inside, which may provide optimal heating and cooling performance.

As shown in FIG. 5 (using overhead/cross-section perspective), the electrode roll 520 comprises a long sheet, comprising electrode material 524 applied on current collector (e.g., copper) 526, that is rolled on a core 522, thus creating alternating layers of electrode material 524 and current collector 526 (as shown in FIG. 5). In this regard, while the layers of electrode material 524 and current collector 526 may appear as concentric, the electrode roll 520 illustrated in FIG. 5 actually spiral-wound, with each of the electrode material 524 and current collector 526 layer actually comprising a single spiral-wound layer around the core 522. Nonetheless, the invention is not limited to such spiral-wound based rolls, and it applies similarly to other roll designs (including rolls comprising separate concentric layers).

The core 522 may be cylindrical in shape. To accommodate the thermal rod 510 (and use thereof), the core 522 is hollow, thus creating a corresponding internal space 528. The thermal rod 510 may be configured such that it may be inserted into the internal space 528, thus engaging the electrode roll 520.

In some instances, the thermal rod 510 may be configured such as it may accommodate pre-arranged rolls—that is, the thermal rod 510 is implemented to accommodate existing electrode rolls. Alternatively, electrode rolls may be made to accommodate existing thermal rods. In some implementations, the thermal rods may incorporate a degree of adjustability, to allow for accommodating different rolls (e.g., with different internal spaces, where the thermal rod may engage the electrode rolls).

In operation, once engaged with (e.g., inserted into) the electrode roll 520, the thermal rod 510 may be configured to provide thermal transfer onto the electrode roll 520 during processing thereof, particularly during pyrolysis processing. In this regard, heating (or cooling) electrode rolls from the inside may be desirable is it may be optimal compared to other means of thermal transfer—e.g., convection heating may not be efficient. Conductive thermal transfer, as would be used in the arrangement shown in FIG. 5, may be more efficient than other approaches. This may particularly be the case with the layers of collector foils within the electrode roll (and particularly when the collector foil comprises copper). For example, in a heating scenario, the thermal rod 510 may be used to heat the core 522 (which may typically comprise metallic material), which in turn allows for quick and uniform heating of the electrode material 524.

The thermal rod 510 may also be used to enhance thermal transfer with respect to cooling. In this regard, the limiting factor in pyrolysis may be the cooling, as it needs to be done in particular manner to protect the electrode—e.g., the electrode roll is preferably not exposed to air while hot as the materials within the electrode roll may react with oxygen, moisture, or other components in air, and cooling is exponential, so it may take long time at low temperatures. Accordingly, the thermal rod 510 may be used to cool the electrode roll 520 in a controlled manner. The thermal rod 510 may be used to cool the core. In some instances, the same thermal rod 510 may be used to provide both heating and cooling; in other instances, separate heating and cooling rods maybe inserted in the core.

In some implementations, the thermal rod 510 may be configured to perform thermal transfer based on particular profiles or models. For example, when used in cooling electrode rolls, the thermal rod 510 may be configured to conform to a cooling curve that is determined to be optimal for particular electrode rolls. Additional measures may be used to ensure conformity to such models (or curves). For example, in some implementations, liquid coolant may be added in the thermal rod 510, at the lower temperatures, to accelerate the slowest portion of the cooling curve.

The thermal rod 510 and/or the electrode roll 520 may be configured to ensure tight connection therebetween. In this regard, as noted above, the thermal rod 510 may be shaped and sized such that it matches the interior space 528 (and/or, conversely, the electrode roll 520 may be construed such that its interior space 528 is shaped and size to match the thermal rod 510), to ensure that tight connection is maintained between the thermal rod 510 and the electrode roll 520.

In some instances, to further enhance thermal transfer characteristics, the thermal rod 510 may comprise similar material as the core 522, thus ensuring uniform and complete thermal transfer from the thermal rod 510 into the electrode roll itself—that is, the electrode material 524 and the collector foil 526. In some instances, the thermal transfer may be further enhanced by use of lubricant between the thermal rod 510 and the electrode roll 520 (or specifically the internal surface of the core 522. The lubricant may comprise, for example, graphite which may be preferable as it may lubricate in high heating temperatures.

In some implementations, an insulator coat 530 may be applied to the exterior surface of the electrode roll 520. This may be done to enhance the thermal processing of the electrode roll, as use of insulation around the electrode roll allows for maintaining the heat (and/or cooling) within the electrode roll.

FIG. 6 illustrates example use of an electrode roll incorporating a thermal rod in a furnace, in accordance with an example embodiment of the disclosure. Shown in FIG. 6 is a furnace 600 which may be used for electrode processing. In particular, the furnace 600 may be used during pyrolysis processing of electrodes (including electrode rolls, such as the electrode roll 520). The furnace 600 may be configured for supporting controlled thermal transfer during electrode processing. In particular, the furnace 600 may be configured to support use of thermal rods, such as the thermal rod 510.

As shown in FIG. 6, the electrode roll 520 is processed in the furnace 600 with the thermal rod 510 engaged therewith (e.g., inserted into it). The electrode roll/thermal rod combination may be arranged vertically. Alternatively, the electrode roll/thermal rod combination may be arranged horizontally—that is sideways. Such horizontal orientation may allow for moving the electrode rod 520 more easily within the furnace 600. For example, the thermal rod 510 may be configured such that when used in horizontal orientation, it may engage a moving mechanism within the furnace 600 to allow using the thermal rod to carry the electrode roll in electrode processing machines (e.g., in conveyer-like manner).

As noted above, in some instances, thermal rods may be used in conjunction with external thermal sources. For example, as shown in FIG. 6, the furnace 600 may incorporate external thermal sources 610, which may be disposed around the space where the electrode roll/thermal rod combination is placed when performing electrode processing (particularly pyrolysis processing).

The external thermal sources 610 may be configured for operation in a coordinated manner with the thermal rod 510, to optimize the electrode processing. For example, external thermal sources 610 may be configured for heating, thus operating as heat sources on the exterior of the electrode roll 520. Using the external thermal sources 610 in this manner while the thermal rod 510 is being used to heat the electrode roll 520 from the inside may ensure maintaining uniform heat across the electrode roll 520. To that end, the heating of the external thermal sources 610 and the thermal rod 510 may be controlled (e.g., continually monitored, and if necessary adjusted) to ensure uniform heating. As such, the furnace 600 may incorporate components (e.g., sensors, control circuitry, etc., not shown) to provide the necessary sensory and control functions.

In some instances, the external thermal sources 610 and the thermal rod 510 may be configured for performing different thermal functions. For example, only the external thermal sources 610 may be configured to function as heating source(s), thus providing heat only from the outside of the electrode rolls, while the thermal rod 510 is configured to provide cooling from the interior of the electrode rolls, and use the rod(s) only for cooling.

FIG. 7 illustrates an example use of multiple electrode rolls, each incorporating a thermal rod in a continuous batch furnace, in accordance with an example embodiment of the disclosure. Shown in FIG. 7 is a continuous batch furnace 700, which may be used for electrode processing. The furnace 700 may be similar to the furnace 600 described above, and may similarly be used and operate in similar manner during processing (particularly pyrolysis processing) of electrodes (including electrode rolls, such as the electrode roll 520). The furnace 700 may be configured for continuous batch processing, however.

The furnace 700 may support processing multiple electrode rolls 520, including multiple rolls having thermal rods 510 inserted into them. This may allow performing electrode processing of these rolls, with controlled thermal transfer, using the thermal rods 510, and (optionally) external thermal sources (not shown). In some instances, the furnace 700 may be configured to process the electrode rolls 520 similarly at the time—that is, perform the same thermal transfer functions all the rolls 520 at the same time, using the corresponding thermal rods 510 (and, if used, external thermal sources). The disclosure is not so limited, however.

For example, in some instances, the furnace 700 may be configured to operate in conveyer-manner, with different processing steps (and thus, any corresponding thermal transfer functions associated therewith) on the electrode rolls 520 as they move within the furnace 700. Furthermore, the electrode rolls may proceed through the furnace with the thermal rods arranged horizontally, as opposed to vertically.

An example apparatus for processing battery electrodes, in accordance with the present disclosure, comprises a thermal rod, with the thermal rod being configured for engaging an electrode roll. At least a portion of the thermal rod is disposed within the electrode roll once it is engaged with the electrode roll, and the thermal rod is configured for providing thermal transfer into the electrode roll during processing of the electrode roll, with the processing comprising pyrolysis processing of the electrode roll.

In an example embodiment, the thermal rod is configured for providing one or both of cooling thermal transfer and heating thermal transfer.

In an example embodiment, the thermal rod is configured for providing cooling thermal transfer based on a predefined cooling model for the electrode roll.

In an example embodiment, the thermal rod is configured for engaging the electrode roll by insertion via an internal space within the electrode roll.

In an example embodiment, the electrode roll comprises a hollow cylindrical core creating a corresponding cylindrical space within the electrode roll, with the thermal rod being configured for engaging the electrode roll by insertion via the cylindrical space within the core of the electrode roll.

In an example embodiment, one or both of a shape and a size of the thermal rod are configured based on at least one component of the electrode roll.

In an example embodiment, the electrode roll comprises a hollow cylindrical core creating a corresponding cylindrical space within the electrode roll, and one or both of the shape and the size of the thermal rod are configured to match the cylindrical space.

In an example embodiment, at least a portion of the thermal rod comprises same material as at least one component of the electrode roll.

In an example embodiment, the electrode roll comprises a hollow cylindrical core, with the thermal rod comprising same material as the core.

In an example embodiment, a lubricant is disposed between the thermal rod and the electrode roll. The lubricant may comprise graphite.

In an example embodiment, an insulator is disposed over at least a portion of an exterior surface of the electrode roll.

In an example embodiment, the apparatus further comprises one or more thermal sources disposed external to the electrode roll, with the one or more thermal sources being configured for providing thermal transfer in conjunction with the thermal rod.

In an example embodiment, the one or more thermal sources and the thermal rod are configured to provide thermal transfer into the electrode roll to create uniform thermal change within the electrode roll during the pyrolysis processing.

In an example embodiment, the one or more thermal sources are configured to provide, during the processing of the electrode roll, one of cooling thermal transfer and heating thermal transfer, and the thermal rod is configured to provide other one of cooling thermal transfer and heating thermal transfer.

In an example embodiment, the thermal rod is configured for enabling movement of the electrode roll during the processing of the electrode roll.

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. An apparatus for processing battery electrodes, the apparatus comprising:
a thermal rod, wherein:
the thermal rod is configured for engaging an electrode roll, wherein:
the electrode roll comprises a sheet comprising electrode material applied on a current collector rolled to create concentric alternating layers of electrode material and current collector, and
at least a portion of the thermal rod is disposed within the electrode roll once engaged, with at least a portion of the thermal rod being disposed within the concentric alternating layers of electrode material and current collector; and
the thermal rod is configured for providing thermal transfer into the electrode roll during processing of the electrode roll, the processing comprising pyrolysis processing of the electrode roll.

2. The apparatus of claim 1, wherein the thermal rod is configured for providing one or both of cooling thermal transfer and heating thermal transfer.

3. The apparatus of claim 2, wherein the thermal rod is configured for providing cooling thermal transfer based on a predefined cooling model for the electrode roll.

4. The apparatus of claim 1, wherein the thermal rod is configured for engaging the electrode roll by insertion via an internal space within the electrode roll.

5. The apparatus of claim 4, wherein the electrode roll comprises a hollow cylindrical core creating a corresponding cylindrical space within the electrode roll, and wherein the thermal rod is configured for engaging the electrode roll by insertion via the cylindrical space within the core of the electrode roll.

6. The apparatus of claim 1, wherein one or both of a shape and a size of the thermal rod are configured based on at least one component of the electrode roll.

7. The apparatus of claim 6, wherein the electrode roll comprises a hollow cylindrical core creating a corresponding cylindrical space within the electrode roll, and wherein one or both of the shape and the size of the thermal rod are configured to match the cylindrical space.

8. The apparatus of claim 1, wherein a composition of at least a portion of the thermal rod is configured based on at least one component of the electrode roll.

9. The apparatus of claim 8, wherein the thermal rod comprises same material as the current collector.

10. The apparatus of claim 9, wherein the same material comprises copper.

11. The apparatus of claim 8, wherein the electrode roll comprises a hollow cylindrical core, and wherein the thermal rod comprises same material as the core.

12. The apparatus of claim 1, comprising a lubricant disposed between the thermal rod and the electrode roll.

13. The apparatus of claim 12, wherein a lubricant comprises graphite.

14. The apparatus of claim 1, comprising an insulator disposed over at least a portion of an exterior surface of the electrode roll.

15. The apparatus of claim 1, comprising one or more thermal sources disposed external to the electrode roll, the one or more thermal sources being configured for providing thermal transfer in conjunction with the thermal rod.

16. The apparatus of claim 15, wherein the one or more thermal sources and the thermal rod are configured to provide thermal transfer into the electrode roll to create uniform thermal change within the electrode roll during the pyrolysis processing.

17. The apparatus of claim 16, wherein during the processing of the electrode roll, the one or more thermal sources are configured to provide one of cooling thermal transfer and heating thermal transfer, and the thermal rod is configured to provide other one of cooling thermal transfer and heating thermal transfer.

18. The apparatus of claim 1, wherein the thermal rod is configured for enabling movement of the electrode roll during the processing of the electrode roll.
